(19) United States
(12) Patent Application Publication
(10) Pub. No.: US 2026/0324594 A1
(43) Pub. Date: Oct. 22, 2026

(54) Pet Toys

(71) Applicant: Qi Dong, Guangzhou City (CN)

(72) Inventor: Qi Dong, Guangzhou City (CN)

(21) Appl. No.: 19/316,761

(22) Filed: Sep. 2, 2025

(30) Foreign Application Priority Data
Apr. 22, 2025 (CN) 202520773172.6
Apr. 22, 2025 (CN) 202520773184.9
Jun. 5, 2025 (CN) 202521146351.3
Aug. 1, 2025 (CN) 202521631335.3
Sep. 1, 2025 (CN) 202521631325.X

(51) Int. Cl. A01K 15/02; F16B 2/12

(52) U.S. Cl. CPC A01K 15/025; F16B 2/12

(57) ABSTRACT

A pet toy is provided, which includes a housing, a rotating shaft, and a forward-and-reverse motor, an outer side of the housing is provided with an installation groove; the rotating shaft is provided inside the installation groove, and there is a threading hole on the rotating shaft that can fix a rope; the forward-and-reverse motor is provided inside the housing, and is connected to the rotating shaft to control retraction and extension of the rope.

### CROSS-REFERENCE TO RELATED APPLICATIONS

This application claims priority to Chinese patent application 202520773172.6, submitted on Apr. 22, 2025 and entitled with “structure for controlling the up and down jumping motion of a cat toy”; Chinese patent application 202520773184.9, submitted on Apr. 22, 2025 and entitled with “fixed structure for a child and mother buckle used in a cat teasing bouncing device”; Chinese patent application 202521146351.3, submitted on Jun. 5, 2025 and the entitled with “cat teasing device with an external rotating shaft”; Chinese patent application 202521631235.X, submitted on Aug. 1, 2025 and entitled with “Pet Toy”; and Chinese patent application 202521631335.3, submitted on Aug. 1, 2025 and entitled with “Pet Toy”. All of which are hereby incorporated by reference in their entireties.

### TECHNICAL FIELD

The present disclosure relates to the field of pet toys technologies, and in particular, to a pet toy that is convenient for changing ropes.

### BACKGROUND

Some pets have a lively and active nature, such as cats, which have strong curiosity and enjoy chasing moving objects. Therefore, people have designed various sports pet toys for them to play with.

One type of cat toy achieves the bouncing of prey models by controlling the movement of the rope to attract the cat's attention. Connect the prey model to a lower end of the rope, and fix an upper end of the rope on a rotating shaft. Control the rotating shaft to rotate forward or backward through a motor to retract the rope. During a retraction process of the rope, the prey model is pulled by the rope and can achieve a jumping effect.

The rotating shaft of the above-mentioned cat toy is usually built-in, that is, the rotating shaft is located inside the housing and is not visible from the outside. When the rope wears or breaks, the housing needs to be disassembled before replacing the rope, which poses a problem of inconvenient operation.

### SUMMARY

One of purposes of the present disclosure is to provide a pet toy with an external rotating shaft for easy replacement a rope.

In order to achieve the above objectives, the present disclosure adopts the following technical solutions.

A pet toy, including:
a housing, which is provided with an installation groove extending along an outer side of the housing; two side walls of the installation groove are respectively provided with a first installation hole and a second installation hole;
a rotating shaft, which is provided inside the installation groove, and the rotating shaft can fix a rope, a first end of the rotating shaft is provided in the first installation hole, and a second end of the rotating shaft is provided in the second installation hole;
a forward-and-reverse motor, which is provided inside the housing and is connected to the second end of the rotating shaft for transmission to control retraction and extension of the rope.

The pet toy disclosed herein, due to the rotating shaft being provided in the installation groove outside the housing, it does not require dismantling the housing when replacing the rope, an old rope is simply detached from the rotating shaft and a new rope is fixed through a threading hole on the rotating shaft, thereby completing the rope replacement and rendering the operation more convenient.

In some embodiments, the rotating shaft is provided with the threading hole configure for fixing the rope. The threading hole is arranged radially through the rotating shaft.

In some embodiments, the housing includes a main body portion and an extension portion; the extension portion extends along an outer side of the main body portion in a bent shape; the installation groove is formed between the main body portion and the extension portion.

In some embodiments, the main body portion and the extension portion are integrally formed.

In some embodiments, the installation groove is U-shaped.

In some embodiments, the first end of the rotating shaft is provided with a limit flange extending radially, and the first installation hole is provided with a limit protrusion extending axially; the limit flange and the limit protrusion are interlocked to prevent the first end of the rotating shaft from disengaging from the first installation hole.

In some embodiments, the pet toy further includes:
an adhesive piece, where a first side of the adhesive piece is fixed to a load-bearing object by adhesive bonding, and a second side of the adhesive piece opposite to the first side has a clamp holder;
a connector, where a first end of the connector is detachably installed on the clamp holder, and a second end of the connector is fixedly connected to the housing.

In some embodiments, the connector is provided at a top of the housing, and the connector and the housing are integrally formed; an opening of the installation groove faces downwards towards the housing.

The present disclosure further provides a pet toy that can be easily disassembled and assembled.

In order to achieve the above objectives, the present disclosure adopts the following technical solutions.

A pet toy, including:
a main body, which is provided with a rotating shaft and a forward-and-reverse motor, the rotating shaft can fix a rope, and the forward-and-reverse motor is connected to the rotating shaft for transmission to control retraction and extension of the rope;
an adhesive piece, where a first side of the adhesive piece is fixed to a load-bearing object by adhesive bonding, and a second side of the adhesive piece opposite to the first side has a clamp holder;
the main body is further provided with a connector, and the connector has a clamp block that slides into an interior of the clamp holder and adapts to the clamp holder, so that the main body is fixedly connected to the adhesive piece.

The pet toy is disclosed herein, as the adhesive piece is provided with the clamp holder and the connector with the clamp block is provided on the main body. During installation, the main body is simply pushed to slide the clamp block into the interior of the clamp holder and form a clamp connection with the clamp holder, which can fixedly connect the main body and the adhesive piece. When disassembling, the main body is simply pushed in an opposite direction to slide the clamp block from the interior of the clamp holder to the outside of the clamp holder, which can separate the main body from the adhesive piece. Therefore, this disclosure has the advantage of convenient disassembly and assembly.

In some embodiments, a positioning protrusion is provided on the clamp block, and an extension direction of the positioning protrusion is perpendicular to a sliding direction of the clamp block in the clamp holder; a positioning groove is provided in the clamp holder, and after the clamp block slides into place in the clamp holder, the positioning protrusion is adapted and engaged with the positioning groove.

Due to the positioning protrusion on the clamp block being able to be clamped with the positioning groove inside the clamp holder, after the main body is installed, it is not easy to detach from the adhesive piece under non-human interference. Thus, it is more stable.

In some embodiments, the positioning groove is provided on an inner bottom surface of the clamp holder, and the inner bottom surface is opposite to the second side of the adhesive piece. A contact area between the inner bottom surface of the clamp holder is relatively large. Providing the positioning protrusion at this position can make the main body more stable after being provided on the adhesive piece.

In some embodiments, the pet toy further includes:
an adhesive auxiliary component, where a first side of the adhesive auxiliary component is bonded and fixed to a load-bearing object, and a second side of the adhesive auxiliary component opposite to the first side is bonded and fixed to the first side of the adhesive piece.

The adhesive piece and auxiliary adhesive component can make a selection of the load-bearing object to be more diverse, and the fixation of the pet toy more convenient. For example, the load-bearing object can be a wall, a roof, a door panel, etc., changing the current situation where pet toys can only be fixed on a single type of load-bearing object.

In some embodiments, the first side of the adhesive auxiliary component and the second side of the adhesive piece are coated with one of acrylic adhesive, epoxy resin adhesive, silicone adhesive, and hot melt adhesive.

In some embodiments, the main body includes a housing, and an outer side of the housing is bent to form an installation groove;
the rotating shaft is provided inside the installation groove;
the forward-and-reverse motor is provided inside the housing.

In some embodiments, the installation groove is U-shaped.

### BRIEF DESCRIPTION OF DRAWINGS

In order to provide a clearer explanation of the technical solutions disclosed in this embodiment or existing technology, a brief introduction will be given to the accompanying drawings required for the description of the embodiments or existing technology. It is obvious that the accompanying drawings described below are only some embodiments of the present disclosure. For those skilled in the art, other drawings can be obtained based on these drawings without requiring creative work.

FIG. 1 is a first schematic structural diagram of a pet toy provided in an embodiment.

FIG. 2 is a second schematic structural diagram of the pet toy provided in an embodiment, which is formed by disassembling a housing from FIG. 1.

FIG. 3 is a third schematic structural diagram of the pet toy provided in an embodiment, in which a rotating shaft being separated from an installation groove.

FIG. 4 is a fourth schematic structural diagram of the pet toy provided in an embodiment, in which the rotating shaft being separated from the installation groove.

FIG. 5 is a fifth schematic structural diagram of the pet toy provided in an embodiment.

FIG. 6 is a sixth schematic structural diagram of the pet toy provided in an embodiment, in which an adhesive piece being separated from a connector.

FIG. 7 is a seventh schematic structural diagram of the pet toy provided in an embodiment.

FIG. 8 is an eighth schematic structural diagram of the pet toy provided in an embodiment, in which the adhesive piece being separated from the connector.

### DESCRIPTION OF EMBODIMENTS

In order to make the purpose, features, and advantages of the present disclosure to b more obvious and understandable, the technical solutions in the disclosed embodiments will be clearly and completely described below in combination with the accompanying drawings. Obviously, the embodiments described below are only a part of the disclosed embodiments, not all of them. Based on the embodiments disclosed in the present disclosure, all other embodiments obtained by those skilled in the art without creative work are within the protection scope of the present disclosure.

In the description of the present application, it should be noted that terms “up”, “down”, “front”, “back”, “side”, etc. indicate orientation or position relationships based on the orientation or position relationships shown in the accompanying drawings, only for a convenience of describing this application and simplifying the description, and do not indicate or imply that the device or component referred to must have a specific orientation, be constructed and operated in a specific orientation, and therefore cannot be understood as a limitation of this application.

Unless otherwise specified and limited, terms “connection”, “fixation”, and “providing” should be broadly understood, for example, it can be a fixed connection, a detachable connection, or an integral connection; it can be a mechanical connection, a direct connection, an indirect connection through an intermediate medium, or an internal connection between two components. For those skilled in the art, the specific meanings of the above terms in this application can be understood in a specific situation.

Besides that, terms “first”, “second”, and “third” are only used for a descriptive purpose and cannot be understood as indicating or implying relative importance or implying the number of technical features indicated. Therefore, features limited to “first”, “second”, and “third” may explicitly or implicitly include one or more of these features. Unless otherwise specified.

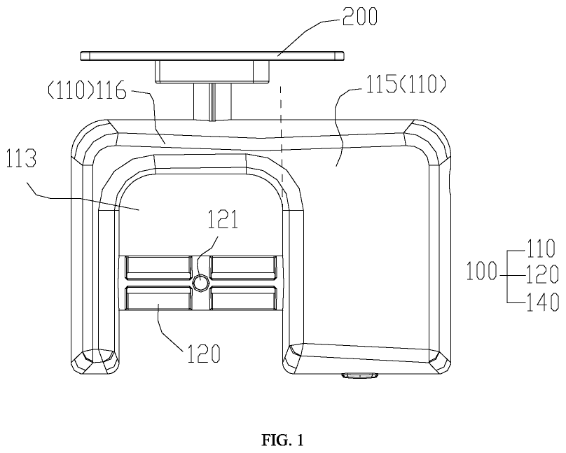

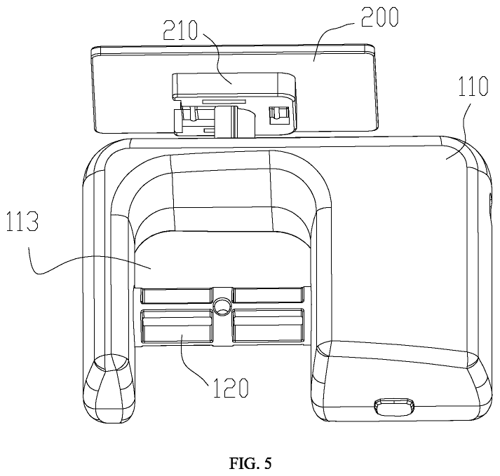

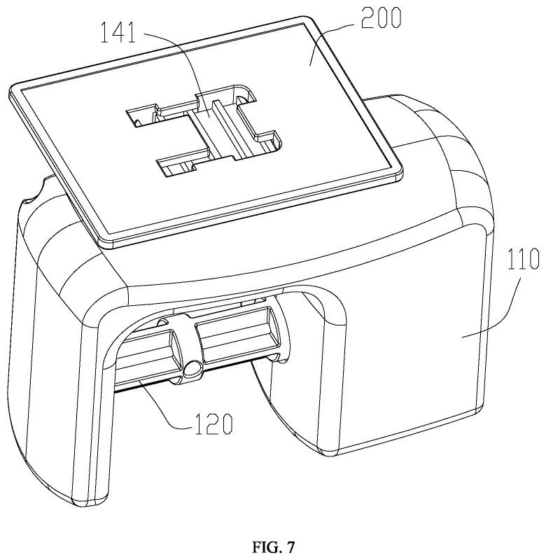

Please refer to FIGS. 1 to 8 together. Below is an introduction to a pet toy based on feature of having an external rotating shaft.

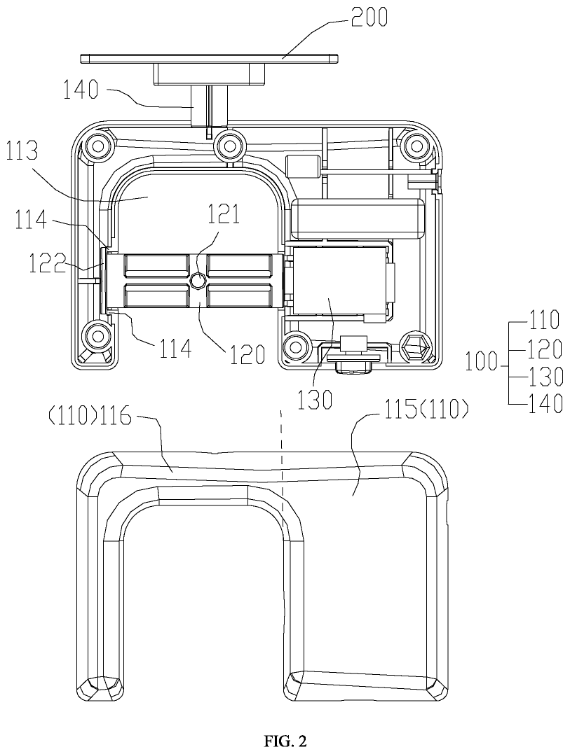

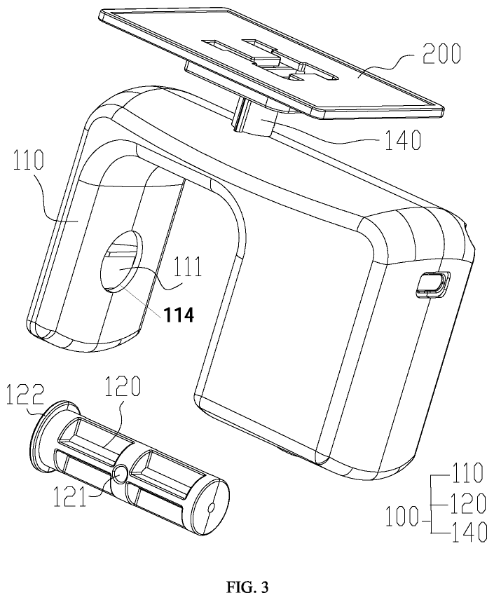

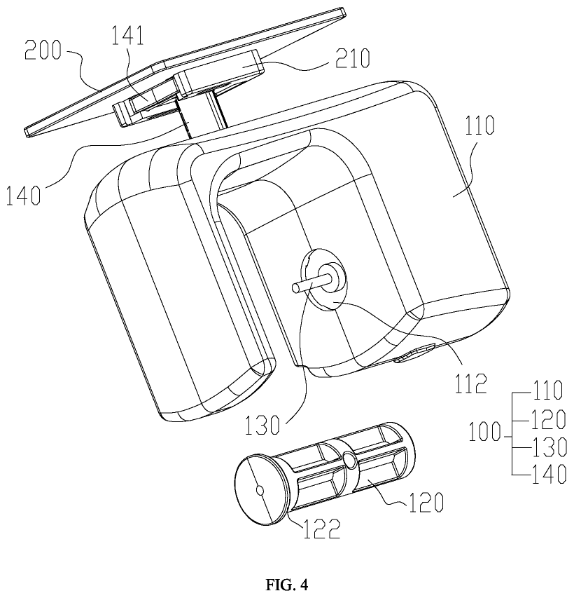

This embodiment discloses a pet toy, which includes:
a housing 110, which is provided with an installation groove 113 extending along an outer side of the housing 110; two opposite side walls of the installation groove 113 are respectively provided with a first installation hole 111 and a second installation hole 112, as shown in FIGS. 3 and 4;
a rotating shaft 120, which is provided inside the installation groove 113, a first end of the rotating shaft 120 is provided in the first installation hole 111, and a second end of the rotating shaft 120 is provided in the second installation hole 112; the rotating shaft 120 is provided with a threading hole 121 for fixing a rope (not shown in the figure); and
a forward-and-reverse motor 130, which is provided inside the housing 110 and is connected to a second end of the rotating shaft 120 for transmission to control retraction and extension of the rope, as shown in FIG. 2.

In this embodiment, the housing 110, the rotating shaft 120, and the forward-and-reverse motor 130 form a motion control device for the rope, which can control the retraction and extension of the rope.

The pet toy of this embodiment, due to the rotating shaft 120 being provided in the installation groove 113 outside the housing 110, that is, the installation groove 113 is in an opened type as a whole, it does not require dismantling the housing 110 when replacing the rope. An old rope is simply detached from the rotating shaft 120, and a new rope is fixed through the threading hole 121 on the rotating shaft 120, thereby completing the rope replacement and rendering the operation more convenient.

In some embodiments, the threading hole 121 is arranged radially through the rotating shaft 120.

In some embodiments, the housing 110 includes a main body portion 115 and an extension portion 116; the extension portion 116 extends along an outer side of the main body portion part 115 in a bent shape; the installation groove 113 is formed between the main body portion 115 and the extension portion 116, as shown in FIGS. 1 and 2.

In an implementation mode, the main body portion 115 and the extension portion 116 are integrally formed, resulting in a more coordinated and compact overall structure.

In an implementation mode, the installation groove 113 is U-shaped.

In an implementation mode, as shown in FIGS. 2 to 4, the first end of the rotating shaft 120 is provided with a limit flange 122 radially extending, and the first installation hole 111 is provided with a limit protrusion 114 axially extending. The limit flange 122 and the limit protrusion 114 can be interlocked to prevent the first end of the rotating shaft 120 from disengaging from the first installation hole 111.

In an implementation mode, the pet toy further includes an adhesive piece 200, a first side of the adhesive piece 200 can be fixed to a load-bearing object (not shown in the figure) by adhesive bonding, and a second side of the adhesive piece 200 opposite to the first side has a clamp holder 210; in this embodiment, the load-bearing object can refer to an object such as a wall, a roof, a door panel, etc. that can provide support.

In an implementation mode, the first side of the adhesive piece 200 can be adhered with an adhesive auxiliary component (not shown in the figure), which can be 3M double-sided tape, that is, the adhesive piece 200 is adhered to the load-bearing object through 3M double-sided tape; of course, the adhesive piece can also be other double-sided adhesive media coated with acrylic adhesive, epoxy resin adhesive, silicone adhesive, or hot melt adhesive.

The pet toy further includes a connector 140, where a first end of the connector 140 can be detachably installed on the clamp holder 210, and a second end of the connector 140 is fixedly connected to the housing 110.

The adhesive piece can make a selection of the load-bearing objects to be more diverse, and the fixation of the pet toy more convenient. For example, the pet toy can be glued and fixed to a wall, a roof, a door panel, etc., changing the current situation where pet toys can only be fixed to a single type of load-bearing object.

In an implementation mode, the connector 140 is fixedly provided at a top of the housing 110, and the connector 140 and the housing 110 are integrally formed; an opening of the installation groove 113 faces downwards towards the housing 110.

Please continue to refer to FIGS. 1 to 8. The following introduces a pet toy that is convenient disassembly and assembly.

This embodiment discloses a pet toy, which includes a main body 100 that is provided with a rotating shaft 120 and a forward-and-reverse motor 130, the rotating shaft 120 can fix a rope (not shown in the figure), and the forward-and-reverse motor 130 is connected to the rotating shaft 120 for transmission to control retraction and extension of the rope.

In this embodiment, the main body 100 includes a housing 110, and an outer side of the housing 110 is bent to form an open-type installation groove 113; the rotating shaft 120 is provided inside the installation groove 113, and the rotating shaft has a threading hole 121 for fixing the rope; the forward-and-reverse motor 130 is provided inside the housing 110.

The pet toy further includes an adhesive piece 200, a first side of the adhesive piece 200 can be fixed to a load-bearing objects (not shown in the figure) by adhesive bonding, and a second side of the adhesive piece 200 opposite to the first side has a clamp holder 210, as shown in FIGS. 4-6.

The main body 100 is further provided with a connector 140, and the connector 140 has a clamp block 141. The clamp block 141 can slide into an interior of the clamp holder 210 and adapt to the clamp holder 210, so that the main body 100 is fixedly connected to the adhesive piece 200.

The pet toy of this embodiment is provided with the clamp holder 210 on the adhesive piece 200, and the connector with the clamp block 141 is provided on the main body 100. During installation, the main body 100 is simply pushed to slide the clamp block 141 into the interior of the clamp holder 210 and form a clamp connection with the clamp holder 210, which can fixedly connect the main body 100 and the adhesive piece 200. When disassembling, the main body 100 is simply pushed in an opposite direction to slide the clamp block 141 from the interior of the clamp holder 210 to the outside of the clamp holder 210, which can separate the main body 100 from the adhesive piece 200. Therefore, this embodiment has the advantage of convenient disassembly and assembly.

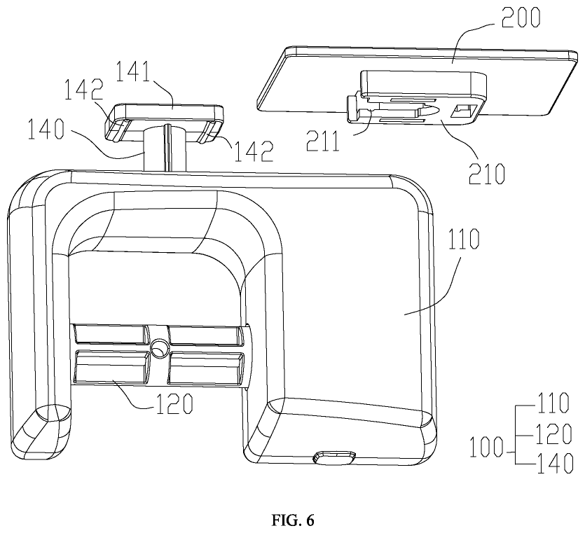

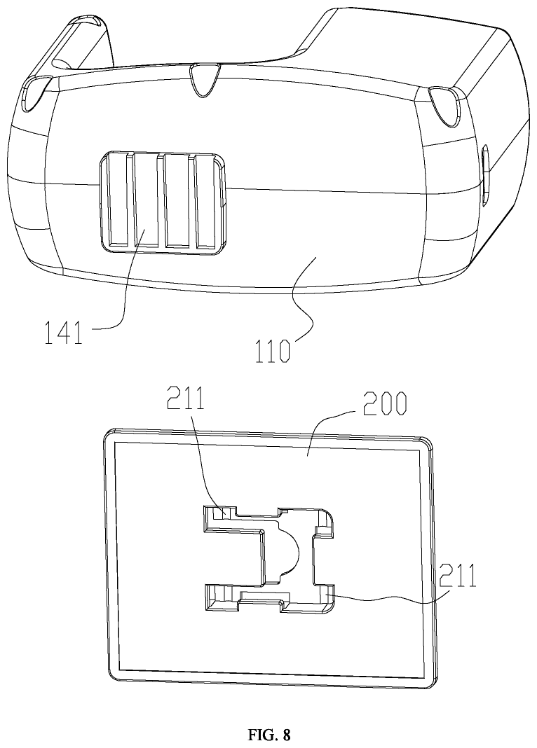

In an implementation mode, as shown in FIG. 6 or FIG. 8, a positioning protrusion 142 is provided on the clamp block 141, and an extension direction of the positioning protrusion 142 is perpendicular to a sliding direction of the clamp block 141 in the clamp holder 210. A positioning groove 211 is provided inside the clamp holder 210. After the clamp block 141 slides into place in the clamp holder 210, the positioning protrusion 142 can be adapted and engaged with the positioning groove 211.

Due to the positioning protrusion 142 on the clamp block 141 being able to be clamped with the positioning groove 211 inside the clamp holder 210, after the main body 100 is installed, it is not easy to detach from the adhesive piece 200 without human interference. Thus, it is more stable.

In an implementation mode, the positioning groove 211 is provided on an inner bottom surface of the clamp holder 210, and the inner bottom surface is opposite to the second side of the adhesive piece. A contact area between the inner bottom surface of the clamp holder 210 and the clamp block 141 is relatively large. Providing the positioning protrusion 142 at this position can make the main body 100 more stable after being provided on the adhesive piece 200.

In an implementation mode, the pet toy further includes an adhesive auxiliary component (not shown in the figure), a first side of the adhesive auxiliary component can be bonded and fixed to the load-bearing object, and a second side of the adhesive auxiliary component opposite to the first side can be bonded and fixed to the first side of the adhesive piece 200.

The adhesive piece can make a selection of the load-bearing object to be more diverse, and the fixation of the pet toy to be more convenient. For example, the load-bearing object can be a wall, a roof, a door panel, etc., changing the current situation where pet toys can only be fixed on a single type of load-bearing object.

In an implementation mode, the adhesive auxiliary component may be 3M double-sided tape, i.e., the adhesive piece 200 is adhered to the load-bearing object through 3M double-sided tape. Of course, the adhesive auxiliary component can also be other double-sided adhesive media. The first side of the adhesive auxiliary component and the second side of the adhesive piece can be coated with acrylic adhesive, epoxy resin adhesive, silicone adhesive, or hot melt adhesive.

The above embodiments are only used to illustrate the disclosed technical solution and not to limit it; although the present disclosure has been described in detail with reference to the aforementioned embodiments, those skilled in the art should understand that they can still modify the technical solutions described in the aforementioned embodiments, or equivalently replace some of the technical features; and these modifications or substitutions do not depart from the essence and scope of the corresponding technical solutions disclosed in the present disclosure.

What is claimed is:

1. A pet toy, comprising:
a housing, which is provided with an installation groove extending along an outer side of the housing; two side walls of the installation groove are respectively provided with a first installation hole and a second installation hole;
a rotating shaft, which is provided inside the installation groove, and the rotating shaft can fix a rope, a first end of the rotating shaft is provided in the first installation hole, and a second end of the rotating shaft is provided in the second installation hole;
a forward-and-reverse motor, which is provided inside the housing and is connected to the second end of the rotating shaft for transmission to control retraction and extension of the rope.

2. The pet toy according to claim 1, wherein the rotating shaft is provided with a threading hole configure for fixing the rope.

3. The pet toy according to claim 2, wherein the threading hole is arranged radially through the rotating shaft.

4. The pet toy according to claim 1, wherein the housing comprises a main body portion and an extension portion;
the extension portion extends along an outer side of the main body portion in a bent shape;
the installation groove is formed between the main body portion and the extension portion.

5. The pet toy according to claim 4, wherein the main body portion and the extension portion are integrally formed.

6. The pet toy according to claim 5, wherein the installation groove is U-shaped.

7. The pet toy according to claim 1, wherein the first end of the rotating shaft is provided with a limit flange extending radially, and the first installation hole is provided with a limit protrusion extending axially;
the limit flange and the limit protrusion are interlocked to prevent the first end of the rotating shaft from disengaging from the first installation hole.

8. The pet toy according to claim 1, further comprising:
an adhesive piece, wherein a first side of the adhesive piece is fixed to a load-bearing objects by adhesive bonding, and a second side of the adhesive piece opposite to the first side has a clamp holder;
a connector, wherein a first end of the connector is detachably installed on the clamp holder, and a second end of the connector is fixedly connected to the housing.

9. The pet toy according to claim 2, further comprising:
an adhesive piece, wherein a first side of the adhesive piece is fixed to a load-bearing objects by adhesive bonding, and a second side of the adhesive piece opposite to the first side has a clamp holder;
a connector, wherein a first end of the connector is detachably installed on the clamp holder, and a second end of the connector is fixedly connected to the housing.

10. The pet toy according to claim 7, further comprising:
an adhesive piece, wherein a first side of the adhesive piece is fixed to a load-bearing objects by adhesive bonding, and a second side of the adhesive piece opposite to the first side has a clamp holder;
a connector, wherein a first end of the connector is detachably installed on the clamp holder, and a second end of the connector is fixedly connected to the housing.

11. The pet toy according to claim 10, wherein the connector is provided at a top of the housing, and the connector and the housing are integrally formed;
an opening of the installation groove faces downwards towards the housing.

12. A pet toy, comprising:
a main body, which is provided with a rotating shaft and a forward-and-reverse motor, the rotating shaft can fix a rope, and the forward-and-reverse motor is connected to the rotating shaft to control retraction and extension of the rope;
an adhesive piece, wherein a first side of the adhesive piece is fixed to a load-bearing objects by adhesive bonding, and a second side of the adhesive piece opposite to the first side has a clamp holder;
the main body is further provided with a connector, and the connector has a clamp block that slides into an interior of the clamp holder and adapts to the clamp holder, so that the main body is fixedly connected to the adhesive piece.

13. The pet toy according to claim 12, wherein a positioning protrusion is provided on the clamp block, and an extension direction of the positioning protrusion is perpendicular to a sliding direction of the clamp block in the clamp holder;
a positioning groove is provided in the clamp holder, and after the clamp block slides into place in the clamp holder, the positioning protrusion is adapted and engaged with the positioning groove.

14. The pet toy according to claim 13, wherein the positioning groove is provided on an inner bottom surface of the clamp holder, and the inner bottom surface is opposite to the second side of the adhesive piece.

15. The pet toy according to claim 12, further comprising:
an adhesive auxiliary component, wherein a first side of the adhesive auxiliary component is bonded and fixed to the load-bearing object, and a second side of the adhesive auxiliary component opposite to the first side is bonded and fixed to the first side of the adhesive piece.

16. The pet toy according to claim 15, wherein the first side of the adhesive auxiliary component and the second side of the adhesive piece are coated with one of acrylic adhesive, epoxy resin adhesive, silicone adhesive, and hot melt adhesive.

17. The pet toy according to claim 12, wherein the main body comprises a housing, and an outer side of the housing is bent to form an installation groove;
the rotating shaft is provided inside the installation groove;
the forward-and-reverse motor is provided inside the housing.

18. The pet toy according to claim 13, wherein the main body comprises a housing, and an outer side of the housing is bent to form an installation groove;
the rotating shaft is provided inside the installation groove;
the forward-and-reverse motor is provided inside the housing.

19. The pet toy according to claim 18, wherein the installation groove is U-shaped.
